(19) United States
(12) Patent Application Publication
(10) Pub. No.: US 2026/0097900 A1
(43) Pub. Date: Apr. 9, 2026

(54) ORDER-PICKING APPARATUS, AND METHOD FOR OPTIMISING STORAGE SPACE

(71) Applicant: Kardex Produktion Deutschland GmbH, Neuburg/Kammel (DE)

(72) Inventor: Norbert Bouché, Pleisweiler (DE)

(21) Appl. No.: 19/109,712

(22) PCT Filed: Dec. 20, 2023
(86) PCT No.: PCT/EP2023/087054

§ 371 Date: Mar. 7, 2025

(30) Foreign Application Priority Data
Dec. 20, 2022 (DE) 10 2022 134 217.4

(51) Int. Cl. B65G 1/137

(52) U.S. Cl. CPC B65G 1/1375; B65G 2203/0233; B65G 2203/044

(57) ABSTRACT

The invention relates to an order picking device (1), in particular a storage lift, with at least one retrieval and/or storage point (14) for stored goods (10) and/or stored goods carriers (8), a method for calculating a height distribution (38) of stored goods (10) on a stored goods carrier (8), a computer program product, and a computer-readable memory medium. The order picking device (1) has stored goods carriers (8) that are stored one above the other in storage places (4) and on which stored goods (10) are deposited. The aim of the invention is to make optimal use of the storage space provided by the order picking device (1). For this purpose, the order picking device (1) has at least one detector device (24) for determining a height distribution (38) of the stored goods (10) or of the stored goods carrier (8) and for providing data (28) that represent the height distribution (38). The detector device (24) includes a plurality of reflection light sensors (25) arranged in parallel to one another. The method comprises determining a location-dependent height (26) of stored goods (10) using a plurality of reflection light sensors (25) arranged in parallel to one another.

### REFERENCE TO PENDING PRIOR PATENT APPLICATIONS

This patent application is a 371 national stage entry of pending prior International (PCT) Patent Application No. PCT/EP2023/087054, filed 20 Dec. 2023 by Kardex Produktion Deutschland GmbH for ORDER PICKING DEVICE, AND METHOD FOR OPTIMIZING STORAGE SPACE, which patent application, in turn, claims benefit of German Patent Application No. 10 2022 134 217.4, filed 20 Dec. 2022.

The two (2) above-identified patent applications are hereby incorporated by reference.

### FIELD OF THE INVENTION

The invention relates to an order picking device, a method for calculating a height distribution of stored goods, and a computer program product and a computer-readable data medium. The order picking device has stored goods carriers that are stored in storage places one above the other, and on which stored goods are deposited.

### BACKGROUND OF THE INVENTION

Order picking devices in the form of storage systems are known from DE 42 33 688 A1 and DE 195 01 718 A1, for example, in which initially the maximum height of the stored good on a stored goods carrier is measured, and the stored goods carrier is then stored, as a function of this maximum height, in one of a plurality of storage places situated one above another in a grid spacing. The distance between two stored goods carriers stored one above the other may thus be minimized.

This system has proven successful in practice. However, it is observed that order picking devices in practice often do not utilize the available storage space.

### SUMMARY OF THE INVENTION

The object of the invention, therefore, is to optimize the utilization of the storage space in an order picking device.

This object is achieved, firstly, by an order picking device having at least one retrieval and/or storage point for stored goods and/or stored goods carriers, the order picking device having at least one detector device for determining a height distribution of the stored goods or of the stored goods carrier and for providing data that represent the height distribution, and the detector device including a plurality of reflection light sensors arranged in parallel to one another.

This object is further achieved by a method for calculating a height distribution of stored goods on a stored goods carrier, comprising determining a location-dependent height of stored goods using a plurality of reflection light sensors arranged in parallel to one another.

An overall stack height is the theoretical or calculated height of the stored goods carriers, stacked directly above one another, in at least one storage rack. For calculating the overall stack height, the stored goods carriers may be situated virtually in a grid spacing that is predefined by the order picking device or the storage system. The overall stack height results, for example, from the sum of the greatest heights of the stored goods on the stored goods carriers of at least one storage rack or of the entire order picking device or of the entire storage system, it being additionally possible to take the height of the stored goods carriers and/or the grid spacing into account. When the overall stack height of the stored goods carriers with the stored good redistribution reduced by lost space is compared to the overall stack height of the stowed stored goods carriers, i.e., the stored goods carriers in the (present) state prior to the stored good redistribution reduced by lost space, only the same stored goods carriers are considered. The reflection light sensors are arranged in parallel to one another, and therefore their observation directions, which are determined by the light beams emitted by the reflection light sensors, are situated in parallel to one another.

The invention further relates to a computer program product that includes commands which, when the computer program product is executed by a computer, prompt the computer to carry out the method according to the invention for calculating a height distribution of stored goods on a stored goods carrier, and to a computer-readable data medium on which the computer program product is stored.

By use of the device according to the invention and the method according to the invention, it is possible to optimize the utilization of the storage space. This is made possible due to the fact that, in contrast to the systems from the prior art mentioned at the outset, it is no longer the maximum height of the stored goods, but, rather, the height distribution, i.e., the profile of the height along at least one spatial direction, that is determined.

The invention may be enhanced with the following refinements, which in each case are advantageous alone and arbitrarily combinable with one another. The refining features discussed below may be used without distinction for the order picking device, the method, and the computer program product. If a method feature is involved, the device is readily designed to carry out the method step.

The method may comprise the following method steps, in particular for individual stowed stored goods carriers or all stowed stored goods carriers: determining a height distribution of the stored goods deposited on a stowed stored goods carrier, based on height measurement data; determining, as a function of the determined height distributions, a stored good redistribution that is reduced by lost space, in which at least a portion of the stored goods in the order picking device are distributed differently than on the stowed stored goods carriers, and an overall stack height of the stored goods carriers with the stored good redistribution that is reduced by lost space is smaller than the overall stack height of the same stowed stored goods carrier, and/or generating an image data set that represents a depiction of the stored goods carriers stowed in the storage places, with the height distribution of the stored goods on the particular stored goods carrier at its storage place in the order picking device. The method may in particular be a computer-implemented method.

According to one advantageous embodiment, the reflection light sensors may be directed vertically downwardly. The orientation relates to the observation direction and the emitted light. This has the advantage that during the detection of the heights of the stored goods, no shadows are cast that could disturb or distort the measurement.

The reflection light sensors may preferably be arranged along at least one line. The height distribution of the stored goods may thus be determined with a single measurement along a section over the entire stored goods carrier. A relative movement between the plurality of reflection light sensors and the stored goods carrier preferably takes place, so that the height distribution above the stored goods carrier can be determined. It is thus possible to obtain an overall three-dimensional image of the stored goods on the stored goods carrier. The height distribution may be made up of the individual height distributions determined in a measuring step.

The order picking device may preferably include a transport path along which the stored good and/or the stored goods carrier is transported between the at least one retrieval and/or storage point and a storage place, with the plurality of reflection light sensors situated transversely to the transport path. Each reflection light sensor of the plurality of reflection light sensors may be oriented in such a way that a measuring direction of the corresponding reflection light sensor is preferably perpendicular or transverse to the transport path.

In a further advantageous embodiment of the order picking device, the plurality of reflection light sensors may be situated at a top side of the transport path.

According to a further advantageous embodiment, the plurality of reflection light sensors may be situated at a top side of the retrieval or storage point. This has the advantage that the stored goods situated on the stored goods carrier may be measured prior to storage in the order picking device, and prior to storage may optionally be distributed differently on the stored goods carriers, based on the stored good redistribution of the stored goods reduced by lost space.

Furthermore, during storage and retrieval the stored goods may be situated on the stored goods carrier and pass through a retrieval or storage opening, it being possible for the plurality of reflection light sensors to be situated at the retrieval or storage opening.

Thus, in one embodiment of the order picking device, when a tray or a stored goods carrier for loading with stored goods is moved out of the device, and after loading is moved back into the device, the height of the stored goods situated on the stored goods carrier may be measured upon storing.

In another embodiment of the order picking device, it is also possible for the tray to remain in the device and the user to place a stored good on the tray through an opening. This opening is not the retrieval or storage opening. The storage opening is not passed through until the tray travels farther into the device. The height distribution of the stored goods or of the stored goods carrier may be determined during entry.

The order picking device may advantageously have reflection light sensors with a scanning range up to 750 mm. In other embodiments the reflection light sensors may have scanning ranges greater than 1000 mm, for example for order picking devices having retrieval or storage openings greater than 1000 mm in height.

The reflection light sensors may have background suppression. For this purpose, the reflection light sensors may operate according to the triangulation process, for example. It is particularly advantageous when the reflection light sensors of the detector device are separated from one another by a distance of greater than 10 mm and less than 100 mm. This allows the height distribution of the stored goods on the stored goods carrier to be detected with sufficiently high resolution (measuring points per unit length). It is thus possible to determine, in addition to the height of the stored good, its extension along at least one spatial direction oriented perpendicularly to the vertical.

A loaded stored goods carrier or a loaded tray, by means of which stored goods in the order picking device are transported and stored, may have a deflection with corresponding loading. In the prior art, a clearly defined safety area below a stored goods carrier or below a tray has been kept free, even if no deflection of the stored goods carrier or of the tray occurs.

In one advantageous embodiment, the order picking device may be designed to detect a deflection of a stored goods carrier or a tray and/or to calculate a value that is representative of the deflection.

To detect the deflection, for example a reflection light sensor may detect a base of the stored goods carrier or of the tray. Alternatively or additionally, the order picking device may be designed to detect a change in the height of a stored good that is already present on the stored goods carrier. Furthermore, a sensor that detects the deflection may be situated at the tray. Strictly as an example and without being limited thereto, the sensor may be a strain sensor that may be affixed to the bottom side of the tray. Alternatively or additionally, a photoelectric barrier may detect the deflection, and/or the deflection may be detected from below, for example by means of a photoelectric barrier or light sensor that is directed vertically onto the bottom side of the tray. Alternatively, further types of sensors may be used, in particular sensors that can monitor a bottom side of the tray base. Such a sensor may be, for example, a proximity sensor, a mechanical sensor, a mechanical limit switch, a position switch, or some other sensor.

To calculate a value that is representative of the deflection, the order picking device may be designed to detect a weight value. The order picking device may have scales, for example, for this purpose. In addition, the order picking device may be designed to calculate the deflection as a function of the weight value.

According to the invention, it may thus be detected whether a deflection is present, and how much the stored goods carrier or the tray deflects in comparison to the unloaded state. This deflection may be quantitatively and/or qualitatively incorporated into the determination of the stored good redistribution that is reduced by lost space.

The order picking device may further be designed to reduce, as a function of the deflection, a size of the safety area provided below the stored goods carrier.

It is thus possible, for example, to determine that no deflection is present, and that the safety area below the stored goods carrier, thus far kept free, without deflection may be utilized to arrange stored goods in the order picking device with even less lost space. Without deflection, the stored goods carrier may be situated closer to the stored goods carrier situated below it, or to the stored goods situated below it. The previously used safety area, which basically contributes to the overall lost space and via which a storage place is created, is thus opened up. This allows more compact loading of the order picking device with less lost space.

To avoid a collision of the stored goods carrier, without deflection, with the stored goods situated below it, the safety area may be decreased by 50%, preferably by 75%, more preferably by 90%, so that even though this results in less lost space, a safety area is still reserved. For example, the size of a safety area may correspond to the distance from two grid points of the order picking device. If the order picking device determines that the stored goods carrier is not deflected, the safety area may be reduced to a size corresponding to the distance from a grid point. This decreases the lost space without completely dispensing with a safety area.

If a deflection of the stored goods carrier or of the tray is detected, in one embodiment the size and also the location of this deflection with respect to the stored goods carrier may be determined. This deflection, analogously to the height distribution of the stored goods, may be regarded as a deflection distribution that extends opposite to the height distribution of the stored goods carrier or tray.

Two stored goods carriers may preferably be situated one above the other in such a way that the height distribution of the lower stored goods carrier is approximately complementary to the deflection distribution of the upper stored goods carrier.

The deflection distribution, as described above, may be determined by a reflection light sensor or reflection light sensors, by sensors that are mounted at the base of the tray, or by other sensors. Alternatively or additionally, further optical sensors, for example the measuring light grid present in the retrieval and storage opening, may be used to determine the deflection.

The order picking device may be further improved by having a system for data processing that is designed to calculate, based on the height distribution provided by the detector device, a stored good redistribution that is reduced by lost space, in which at least a portion of the stored goods in the order picking device are distributed differently on the stored goods carriers than on the stowed stored goods carriers, wherein an overall stack height of the stored goods carriers in the stored good redistribution that is reduced by lost space is less than the overall stack height of the same stowed stored goods carriers.

Alternatively or additionally, the system for data processing may be designed to generate an image data set that represents a depiction of the stored goods carriers, stored in the storage places, with the height distribution of the stored goods on the particular stored goods carrier at its storage place in the order picking device.

The system for data processing may be designed to detect the height distribution while the retrieval and storage opening is traveled through.

The order picking device may provide a user with the image data set graphically, optically, or acoustically, and/or may provide a user with handling instructions for reloading stored goods from a stored goods carrier onto another stored goods carrier of the order picking device as a function of the stored good redistribution that is reduced by lost space. Alternatively or additionally, the order picking device may be designed to control a robot for reloading stored goods from one stored goods carrier to another stored goods carrier of the order picking device as a function of the stored good redistribution that is reduced by lost space. Alternatively or additionally, the image data set may be haptically represented for visually impaired persons, for example.

The order picking device may have a first and a second operating state, in the first operating state the order picking device being designed to determine the height distribution of the stored goods or of the stored goods carrier by means of the plurality of reflection light sensors, and in the second operating state the order picking device being designed to provide and/or output alarm signals when at least one reflection light sensor detects an object between the stored goods carrier and the reflection light sensor.

In the first operating state, the order picking device may thus be designed to calculate handling instructions based on the height distribution.

According to one advantageous embodiment, the height distribution may be determined along two spatial directions of the stored good deposited on a stowed stored goods carrier, based on the height measurement data. A two-dimensional height distribution allows a more accurate representation and calculation of the lost space, and thus, an improvement in the storage space optimization. The two spatial directions preferably extend perpendicularly to one another. Together with the height, this may result overall in a three-dimensional depiction of the stored goods carrier with the stored good deposited thereon.

The height measurement data may be two-dimensional in order to determine the height distribution along two spatial directions. Thus, for example, the height measurement data may include two separate data sets, each containing height measurement data along one spatial direction. Alternatively, the height measurement data may also be present in a single data set that contains a height measurement value, as a function of two spatial directions, that is representative of the height of the stored good.

The height measurement data for determining the height distribution of the system for data processing (also referred to as a data processing device) may be retrieved from a memory. The memory may be part of the data processing device or of an external device that is accessible only by the data processing device. The memory may thus, for example, be part of some other or higher-order data processing device. Such a data processing device may be designed, for example, to manage multiple, separate order picking devices or storage systems that are connected to one another by transport systems, for example.

The or each spatial direction along which a height distribution is determined preferably extends in parallel to an edge of a stored goods carrier. The, or the first, spatial direction preferably extends in parallel to a front edge of the stored goods carrier, which for a stowed stored goods carrier extends in parallel to a loading side of a storage rack or storage place. The loading side of a storage rack is the side of the storage rack through which stored goods carriers are moved into or out of a storage place. The spatial direction, as a second spatial direction, may alternatively or additionally extend perpendicularly to the loading side, preferably in parallel to a horizontal narrow side of the stored goods carrier.

The method for calculating the height distribution comprises determining a location-dependent height of the stored good, the method preferably further comprising the method step of providing height data, representing the location-dependent heights, to a system for data processing, and calculating the height distribution from the height data.

The method may be further enhanced in that the method step of determining the location-dependent height of a stored good includes the relative movement of the plurality of reflection light sensors, arranged in parallel to one another, with respect to the stored good.

This has the advantage that a two-dimensional height distribution, and thus a three-dimensional depiction of the stored goods carrier, may be determined.

The computer-readable data medium according to the invention, on which the computer program product is stored, may be transient or persistent The computer-readable data medium may be a magnetic, optical, or electric memory, for example, and may be, but is not limited to, a diskette, a magnetic strip, a CD, a DVD, a ROM or RAM, a hard disk, or an SSD.

The method may in particular be a computer-implemented method. The method or the data processing device may be designed to determine a three-dimensional depiction of the arrangement of the stored good on a stored goods carrier. For example, the image data set may be two-or three-dimensional. The image data set may include a depiction of the storage places, in particular storage racks. A three-dimensional depiction allows a user to create a more accurate image of the occupancy of a stored goods carrier.

The method and the device may be designed to generate markings in the image data set at those locations in the depiction at which a stored good, which in the stored good redistribution reduced by lost space is situated on a stored goods carrier that is different from the stowed stored goods carrier, is represented in the depiction. Such a marking indicates to a user the particular stored good that is to be rearranged. This allows an improvement and increase in efficiency of the human-machine interface. A marking may be an optical or visual marking, for example a representation of a stored good, which is to be rearranged, in a different color than a stored good which is not to be rearranged, and/or a temporally changing representation of the stored good that is to be rearranged, for example blinking.

The order picking device may in particular be a storage system. Both terms are used synonymously in the discussion below.

A further improvement results when the method and the device prompt an automatic transport in succession to a service opening of the storage system, for example, of those stored goods carriers on which a stored good is situated, and which in the stored good redistribution reduced by loss is situated on a stored goods carrier that is different from the stowed stored goods carrier.

The service opening, also referred to as the retrieval and/or storage point, is an opening or location at which a connection from an interior of the storage system to its external surroundings is provided. The service opening may be a simple opening in an enclosure of the storage system. The service opening may also have a shaft-like design, and for example may be bordered by storage places at the top, bottom, and/or sides. The service opening may also project from the enclosure of the storage system and have additional elements such as one or more tables, one or more dockable transport cars for one or more stored goods carriers or one or more platforms, which may also be situated outside the enclosure. Lastly, the service opening may also be designed as a completely open transfer area at which stored goods and/or stored goods carriers for the storage and/or retrieval are accepted into or transferred from the storage system.

According to a further embodiment, the method and the device may be designed to prompt an automatic, simultaneous transport from at least two stored goods carriers to a service opening, wherein situated on one of the at least two stored goods carriers is a stored good which, according to the stored good redistribution that is reduced by lost space, is supposed to be situated on the other of the at least two stored goods carriers. Such an embodiment allows a redistribution of the stored good to be made very quickly to reduce the lost space.

At least two stored goods carriers may be present in the service opening at the same time. The at least two stored goods carriers may be situated in the service opening one above the other and/or next to one another. Stored goods carriers situated next to one another, in particular when they have a rectangular outline, may be situated with oppositely facing short edges and/or with oppositely facing long edges in a shared plane. This measure also reduces the time required for redistribution of the stored good.

The at least two stored goods carriers situated in the service opening do not have to be stored goods carriers on which stored goods are exchanged. A stored goods carrier in the service opening may also be used, for example, for temporary storage of a stored good of some other stored goods carrier in the service opening, which in a further step is then stored on a third stored goods carrier in the stored good redistribution that is reduced by lost space.

A service opening in which at least two stored goods carriers are receivable offers the advantage that the one, first stored goods carrier is deposited in the service opening at the bottom, for example. While the operator is removing from this stored goods carrier the stored good that is to be rearranged in the course of the stored good redistribution reduced by lost space, the conveying device may convey into the service opening, for example above the first stored goods carrier, a second stored goods carrier on which the rearrangement is to take place. The operator may rearrange the stored good, which is to be rearranged, on the second stored goods carrier while the conveying device once again conveys the first stored goods carrier into a storage place. The two stored goods carriers may be offset above one another in the service opening, so that there is no, or only partial, overlap between them.

The above-mentioned “prompting” with regard to the transport of stored goods carriers is understood to mean an output of control commands, for example to a control device, a transfer of movement coordinates, for example to a control device, retrieval of a control program for controlling the transport, and/or controlling the transport per se, i.e., direct control if a controller is integrated into the device. With this feature, it is possible for an operator to be automatically provided with those stored goods carriers at the service opening for which an at least partial rearrangement of the stored good on other stored goods carriers results in optimization of storage space. A conveying device may be provided for the transport. The data processing device may be designed to calculate the sequence of the automatic transport of the stored goods carriers to a service opening as a function of the stored good redistribution that is reduced by lost space.

According to a further advantageous embodiment, the method and the device may be designed to mark in the service opening, in particular optically and in a contactless manner, the stored good which in the stored good redistribution reduced by lost space is situated on a different stored goods carrier than the stored goods carrier presently situated in the service opening. For example, a display that designates the stored good to be rearranged may be directly or indirectly activated at the service opening. Thus, a laser pointer, a light beam, or a light cross may be directly or indirectly controlled in such a way that it is directed onto the stored good which in the stored good redistribution that is reduced by lost space is situated on a different stored goods carrier than the stored goods carrier that is in the service opening at that moment, i.e., which must be reloaded.

According to a further embodiment, the method and the device may be designed to directly or indirectly control a robot that automatically reloads stored goods from one stored goods carrier to another stored goods carrier as a function of the stored good redistribution that is reduced by lost space. For the reloading, the stored good to be rearranged may automatically be temporarily stored, for example on a table, on a platform, or in a buffer storage space such as a storage rack or a stored goods carrier. The temporary storage space is preferably situated adjacent to the service opening. When at least two stored goods carriers can be present in the service opening at the same time, as described above, one of the stored goods carriers may also be used as a temporary storage space.

Direct control takes place when the robot, the conveying device, or the transfer device is directly controlled by the data processing device or the computer-implemented method. Indirect control means that an external control device is prompted by the method and/or the device to perform such control itself. Of course, the control may also be part of the data processing device or of the storage system.

The storage system may be a storage lift, a paternoster lift, a horizontal carousel, a vertical carousel, or a small parts warehouse, high rack warehouse, or some other storage system with an aisle conveyor. The data processing device or the storage system may have at least one height measuring system as a detector device for detecting the height measurement data. The detector device, i.e., the height measuring system, is preferably situated in the storage system, for example in the service opening, in a storage shaft between storage racks which contain the storage places, and/or in a transition between the service opening and the storage shaft.

The detector device is in particular a height measuring system.

The height measuring system, in addition to the plurality of reflection light sensors, may have at least one light grid, one light curtain, at least one camera, and/or at least one scanner, for example in particular a 3D scanner such as a lidar device, or combinations thereof.

The height measurement data for a stored goods carrier are preferably detected by the plurality of reflection light sensors in the storage system, in particular during the transport of the stored goods carrier in the storage system, for example in the service opening or in the storage aisle. Detection of the height measurement data in the storage system results in a structurally compact approach. Detection of the height measurement data during the transport of a stored goods carrier in the storage system also avoids time losses. Alternatively or additionally, the height measuring system or a portion thereof may be moved relative to the stored goods carrier during detection of the height measurement data. For this purpose, the stored goods carrier may be stationary relative to a storage place, for example. For example, a scanner, a light curtain, or a corresponding light grid for detecting the height measurement data, movably mounted in the service opening, may be moved along a stored goods carrier situated in the service opening.

According to a further advantageous embodiment, the height measuring system may at the same time be part of a security system that monitors the service opening and that is designed, for example, to optically monitor a safety area, and to trigger an alarm when the security zones are penetrated by objects. This corresponds to the second operating state of the order picking device.

It may be further provided to determine or calculate a size that is representative of the lost space of a stowed stored goods carrier, as a function of height distributions of the stowed stored goods carrier. A representation of this size may be contained in the depiction, for example as a visual element, i.e., a number, a graphical illustration, a logo, a progress bar or loading bar, or a combination thereof. In particular, the depiction may contain a representation of the difference in the lost space that results from a comparison of the lost space in the stored good redistribution, reduced by lost space, with the lost space for the presently stowed stored goods carriers. This allows an operator to assess the effectiveness of the stored good redistribution that is reduced by lost space.

To enhance the calculation of the stored good redistribution that is reduced by lost space, a total lost space may be determined which represents the sum of a plurality of lost spaces of different stowed stored goods carriers. In particular, the depiction may contain the difference in the overall stack height, and/or the difference between the total lost space for the stored good redistribution that is reduced by lost space and the overall stack height, and/or the total lost space of the presently stowed stored goods carriers.

To calculate the stored good redistribution that is reduced by lost space, it is only necessary, for example, to minimize the overall stack height and/or the total lost space. A Monte Carlo simulation or a machine learning program that has been trained with such simulations may be used for such a minimization.

It is also advantageous when a warning signal is generated as a function of whether a lost space and/or total lost space or a size that is representative thereof exceeds a predetermined limit value. The limit value may be changeable by the user.

The transport of a stored goods carrier in the storage system may take place as a function of the height distribution, the lost space, and/or the total lost space. For example, transport of a stored goods carrier from the service opening and/or into a storage place may be automatically prevented or stopped when the lost space of this stored goods carrier exceeds a predetermined limit value. A stored goods carrier with lost space above a limit value, for example after determining the height distribution or calculating the lost space, may be automatically transported back into the service opening without being stored.

A further advantage results when the method and the device are designed to automatically identify a stored good on the stored goods carrier. Identification of the stored good may take place via the height distribution and/or by querying a database.

For example, a database in which the position of a stored good on the individual stored goods carrier is stored may be queried. The location of the stored good may be correlated with the height distribution in order to assign the stored good in each case to various heights in the height distribution.

In a further embodiment, data that are representative of at least one dimension of the stored good may be read out from the database. An enhanced calculation and easier identification and display of a stored good to be rearranged are possible by use of these data. The identification of the stored good facilitates the display in the service opening, for example by use of a pointer or on a display. Furthermore, additional data which allow an operator to recognize a stored good may be provided in the depiction, based on queried data from the database.

The database may be part of the data processing device, or may be an external database that is accessible by the data processing device.

When a robot that allows optical recognition of a stored good is activated to automatically rearrange the stored good, an image or the height distribution of the stored goods to be rearranged may be delivered to the robot. Such an image may be generated by the height measuring system, for example. This measure prevents incorrect resorting by the robot.

Lastly, the invention relates to a computer program product that includes commands which, when the computer program product is executed by a computer, prompt the computer to carry out the method in one of the above embodiments. The computer program product may be stored on a computer-readable data medium or may be part of a data medium signal that is transferred by a computer program product as described above.

Any type of computer, for example a standard industrial PC, may be used as a data processing device. The data processing device has a processor which may be made up strictly of hardware, strictly of software, or a combination of hardware and software. A CPU, an array processor, a vector processor unit, an ASIC, a GPU, an FPGA, any other processor, and/or an arbitrary combination of these elements may be used as a processor.

The storage system is an automatic storage system that is designed to automatically stow stored goods for storage as the result of a control command, and automatically retrieve them for the retrieval.

The invention is explained below by way of example, based on embodiments with reference to the appended drawings. For the sake of simplicity, the same reference numerals are always used for elements that correspond to one another with regard to function and/or design.

According to the above embodiments, for any of the embodiments described below a feature may be omitted when its technical effect is not relevant for a certain application. Furthermore, according to the above embodiments, features whose technical effect is relevant for a certain application may be added.

### BRIEF DESCRIPTION OF THE DRAWINGS

In the figures:

FIG. 1 shows a schematic sectional illustration of an example of a storage system;

FIG. 2 shows an example illustration of a height distribution;

FIG. 3 shows a schematic sectional illustration of an example of a storage system;

FIG. 4 shows a schematic view of a portion of FIG. 3 in the viewing direction IV in FIG. 3;

FIG. 5 shows an example illustration of a height distribution;

FIG. 6 shows a schematic sectional illustration of an example of a storage system;

FIG. 7 shows an example illustration of a height distribution;

FIG. 8 shows a schematic sectional illustration of an example of a storage system;

FIG. 9 shows a schematic sectional illustration of an example of a storage system;

FIG. 10 shows an example illustration of a depiction of a storage area of a storage system that is generated from height distributions;

FIG. 11 shows an example illustration of a flow chart;

FIG. 12 shows a schematic illustration of the height measuring system;

FIG. 13 schematically shows the optimization of the utilized storage space during deflection of the stored goods carrier;

FIG. 14 schematically shows the optimization of the utilized storage space during deflection of the stored goods carrier;

FIG. 15 schematically shows the optimization of the utilized storage space when it is detected that no deflection is taking place; and

FIG. 16 schematically shows the utilization of the safety area as a storage volume for an undeflected stored goods carrier.

### DETAILED DESCRIPTION OF THE PREFERRED EMBODIMENTS

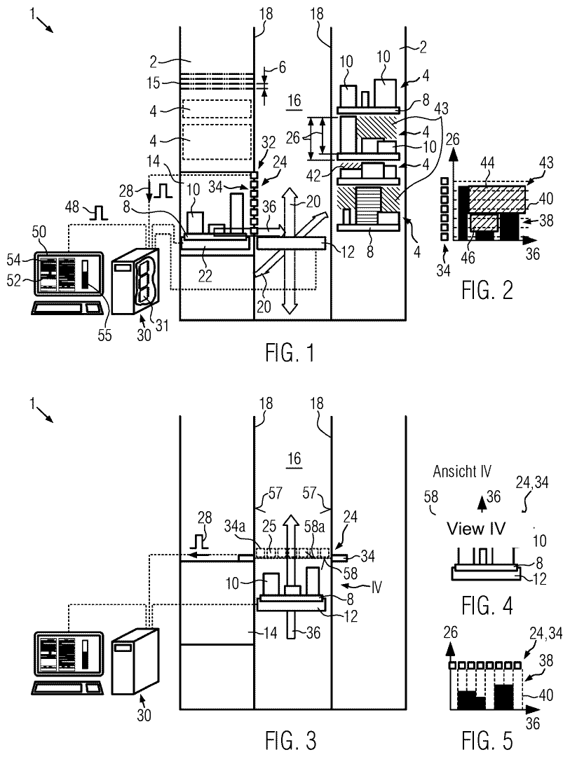

One embodiment of the invention is first explained by way of example, with reference to FIG. 1.

FIG. 1 shows a cross section of an order picking device 1, in particular an automatic storage system 1. The storage system may be a storage lift as illustrated here by way of example. However, the storage system 1 may also be a paternoster lift, a horizontal carousel, a vertical carousel, or a storage system with an aisle conveyor, for example a high rack warehouse or a small parts warehouse.

The storage system 1 has a storage area 2 in which storage places 4 arranged one above the other are situated. The storage places 4 may have different heights and may be arranged in a grid spacing 6. A stored goods carrier 8 on which various stored goods 10 can be deposited may be present in a storage place 4. The stored goods carriers 8 may be stationarily situated at a storage place 4, or for storage may be moved into a storage place 4 and for retrieval may be moved out of a storage place 4.

Any type of stored good may be deposited on a stored goods carrier 8. The stored goods 10 on a stored goods carrier 8 may have different heights. The storage system 1 may also have a conveying device 12 that is used to transport a stored goods carrier 8 for automatic storage into, and/or retrieval of stored goods from, a service opening 14. For a paternoster lift or a horizontal or vertical carousel, the conveying device 12 moves the stored goods carriers 8 along a circular course past the service opening 14, or toward or away from the service opening 14. The service opening 14 connects the storage area 2 to the external surroundings of the storage system 1, and may also be referred to as a storage and/or retrieval point.

For a storage lift or an aisle conveyor, the conveying device 12 may move in a storage aisle 16 that is provided between two storage racks 18 that are opposite one another with respect to the storage aisle 16. In such a case, the conveying device 12 may be movable, for example, along at least two, preferably mutually orthogonal, spatial directions 20. The conveying device may additionally rotate about a vertical axis (not shown).

As an alternative or in addition to the conveying device 12, a transfer device 22 may be situated in the service opening 14, and in the case of storage, moves the one stored goods carrier 8 from the service opening 14 to the conveying device 12, and/or in the case of retrieval, moves the one stored goods carrier from the conveying device 12 to the service opening 14.

The storage system 1 may have any given number of service openings 14. Individual service openings may be utilized only for storage, only for retrieval, or for both. The service opening 14 may have a shaft-like design. For example, storage places may be present above, below, and/or at the sides of the service opening. However, the service opening may also be a simple opening in an enclosure 15 of the storage system which allows access to the storage area.

The storage system 1 may have a height measuring system 24 which may be used to measure a height 26 only of the stored good 10 on the stored goods carrier 8, or of the stored goods carrier 8 together with the stored good 10 present thereon, at multiple positions along at least one spatial direction 20. These spatial directions do not have to match the movement directions of the conveying device or of the transfer device 22.

The height measuring system 24 is designed to generate in particular digital height measurement data 28, which may be output to a system for data processing or a data processing device 30. The system for data processing may be referred to as a data processing device 30. The height measurement data 28, for different positions along the spatial direction 20, contain in encoded form the height 26 measured at a position. The data processing device 30 may at the same time be used to control the conveying device 12 and/or the transfer device 22.

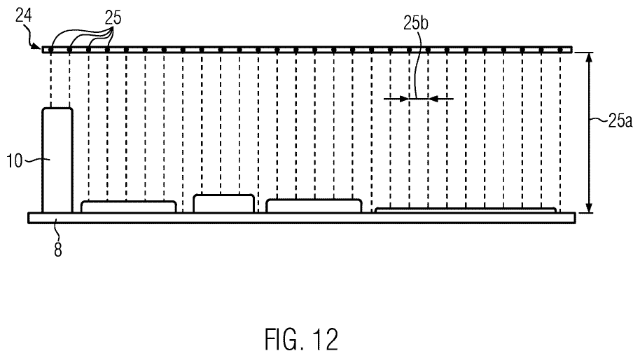

As schematically illustrated in FIG. 12, the height measuring system 24 includes a plurality of reflection light sensors 25. These have a scanning range 25a which preferably may be at least 750 mm, more preferably 1000 mm or greater. In addition, the reflection light sensors 25 are arranged along a line at a distance 25b from one another. The distance 25b may be greater than 1 cm and less than 10 cm. The reflection light sensors 25 have the advantage that they do not cast shadows that could disturb or prevent a height measurement.

The data processing device 30 is designed, for example, to determine, as a function of the height measurement data 28, a storage place 4 into which a stored goods carrier 8 having the measured height 26 fits, or to deposit a stored goods carrier 8 in the grid spacing 6 in the storage area 2 in such a way that, taking into account the height 26, the distance to the storage place 4 situated thereabove is as small as possible.

The data processing device 30 may be a standard computer, for example a PC. The data processing device has one or more processors 31, for example CPUs, vCPUs, ASICS, VPUs, array processors, or combinations thereof on which software having the function described below is executed. A portion or all functions may also be executed by hardware. In the exemplary embodiment in FIG. 1, at least a portion of the height measuring system 24 is situated at the end of the service opening 14 facing the storage area 2, or in a transition area 32 between the service opening 14 and the storage area 2. The height measuring system 24 includes the plurality of reflection light sensors 25, but may additionally have a light grid, multiple light grids, a light curtain, multiple light curtains, a camera, multiple cameras, a scanner, and/or multiple scanners or combinations thereof. The scanner(s) may in particular generate three-dimensional data. For example, a lidar scanner may be used. By use of a laser beam and/or a light beam, for example, a light curtain may scan a measuring plane through which a stored goods carrier is transported and/or which is moved relative to a stored goods carrier. FIG. 1 illustrates a light curtain or light grid 34 strictly by way of example.

The height measuring system 24 may at the same time serve as a security system to enhance work safety. For example, an alarm signal may be output when an object penetrates the light curtain 34 while the security system is armed. For example, the security system may be armed when a stored goods carrier 8 is stationarily situated in the service opening 14 and is being loaded or unloaded.

When a stored goods carrier 8, for storage of a stored good deposited thereon, is transported from the service opening 14 toward the storage places 4 by means of the transfer device 22 and/or the conveying device 12, the stored goods carrier is led past the light curtain or light grid 34 or transported through same, as indicated by the arrow 36. In the course of this movement, the height 26 is measured at successive points in time and thus at various positions along the stored goods carrier 8. Based on the height measurement data 28 that are measured along the direction 36, the data processing device 30 determines a height distribution 38, as illustrated in FIG. 2 by way of example. The lines 40 are intended to symbolically indicate the height grid in which a light grid measures.

In a height distribution 38, the profile of the height 26 in the direction 36 is depicted at various positions. The direction 36 preferably extends in parallel to an edge of the base area of the stored goods carrier 8, which in the present case is rectangular.

For each stored goods carrier, a lost space 42 may be calculated from the height distribution 38 and the location of the storage places 4 or their vertical distance from one another. The lost space 42 is the empty space above the stored good 10 of a stored goods carrier 8 up to the storage place 4 or stored goods carrier 8 situated thereabove. For example, if a stored good 10 with a large height 26 but only a small base area is situated on a stored goods carrier 8, but next to it is a very low stored good 10, the lost space 42 above the stored goods carrier 8 is rather large. If the total stored goods 10 on a stored goods carrier 8 have approximately the same height and there are no gaps between the stored goods 10, the lost space 42 is then rather small.

For a one-dimensional height distribution 38 as shown in FIG. 2, for example, a measure for the lost space 42 may be calculated very easily as the content of a rectangular area 44 in the height distribution 38 above the second-highest stored good 10 up to the height of the highest stored good 10, or down to the bottom side of the stored goods carrier 8 or storage place 4 situated thereabove. This calculation may be refined by adding in each case the rectangular areas 46 above the second-highest, third-highest, etc., stored good. The sum of the spaces 44 and 46 results in the total lost space 43, as illustrated in crosshatch.

As further described below, the height distribution 38 may also be determined in two directions, preferably along two mutually perpendicular directions. In such a case, the lost space 42, similarly as described above, may be determined as equal to the volume, taking into account the second spatial direction. Such a height distribution is referred to below as a two-dimensional distribution.

The data processing device 30 may be designed to generate an image data set 48 and provide it at an output, for example a digital interface such as HDMI or Bluetooth. The image data set 48 is representable in the form of an image 52 on a display 50, for example, which may be part of the data processing device 30. The image data set 48 represents a depiction of the stored goods carriers 8 stored in the storage places 4, with the height distribution of the stored goods 10 on the particular stored goods carrier. Each stored goods carrier 8 is preferably represented in the depiction at the storage place 4 in the storage system 1 or storage rack 18 at which the stored goods carrier is stored in the storage system 1. The depiction 54 is thus a true representation of the loading state of the storage system 1 or of a storage rack 18.

A depiction 54 is schematically illustrated in FIG. 10. The depiction 54 represents the storage area 2, and contains representations, for example, of the stored goods carriers 8 in a storage rack 18.

The height distribution 38 that is determined by the height measuring system 24, using the height measurement data 28, and by the data processing device 30 is represented for each stored goods carrier 8. In addition, further information concerning the stored good 10 may be represented in the depiction 54, for example an article number and/or a brief description.

Determined lost space 42 may also be marked in the depiction 54, for example by the lost space 42 in the depiction 54 having a different color and/or texture than an area above the stored good 10 that is not determined as lost space 42, and that is not the stored good 10. A temporally variable marking such as blinking may also be provided for the lost space 42.

The depiction 54 allows a user of the storage system 1 to recognize inefficient utilization of the available storage space, and to redistribute the stored good 10 if necessary. This measure is facilitated by additionally displaying the lost space 42.

In addition, a stored good 10a that results in lost space 42 and is to be redistributed onto other stored goods carriers in order to minimize the lost space 42 may be marked in the depiction 54, as indicated by the crosshatch in FIG. 10. A stored good 10a that is higher than a predetermined height, which is changeable by the operator, for example, and/or that is lower than a predetermined but changeable height, may be marked.

It is also possible to mark in the depiction 54 only lost space 42 that is greater than a predetermined limit value, which is preferably changeable by the operator.

The data processing device 30 may be designed to determine a total lost space 43. The total lost space 43 results from a sum of individual lost spaces 42. For example, a total lost space 43 may be calculated for each storage rack 18 or for each storage system 1. In the first case, the lost spaces 42 of a storage rack 18, and in the second case, the lost spaces 42 of the entire storage system 1, are added. In calculating the total lost space 43, it is possible to take into account any lost space 42, or only lost space 42 that meets certain criteria and which, for example, has a predefined minimum size that is preferably changeable by the operator. The geometry of the lost space 42 may also be taken into account. For example, it is possible to take into account only lost space 42 having a sufficient width or base area that is above a predetermined limit value that is preferably changeable by the operator.

The depiction 54 may contain one-or two-dimensional height distributions 38, i.e., height distributions that have been measured along one or along two spatial directions. For example, the depiction 54 may contain a perspective representation of a two-dimensional height distribution 38. In this case, the stored good 10 is representable in three dimensions on each stored goods carrier 8.

A marking 55 that is representative of the efficiency of space utilization in the storage area 2 or in the total lost space 43 may be present in the depiction 54 or the image data set 48. A marking 55 provides the user with a quick indication of whether a redistribution of the stored good 10 is necessary. The marking 55 may, for example, be a function of a ratio or a difference of the total lost space 43 from the total storage space provided by the storage system 1, or of a ratio or a difference of the overall stack height from the total height of the storage space provided by the storage system 1.

The data processing device 30 may also be designed to calculate an overall stack height. The overall stack height is the height of the stored goods carriers 8 stacked directly one above the other in the storage system 1 or in a storage rack 18, for example in the grid spacing 6.

The data processing device 30 may determine, as a function of the determined height distributions 38 or the height measurement data 28, a stored good redistribution that is reduced by lost space. In the stored good redistribution that is reduced by lost space, at least a portion of the stored goods 10 in the storage system 1 are distributed on other stored goods carriers 8 than at the time the height distributions were determined. The overall stack height of these stored goods carriers 8, after the stored good redistribution that is reduced by lost space, is smaller than the overall stack height prior to the stored good redistribution that is reduced by lost space. Thus, in the stored good redistribution that is reduced by lost space, the stored good 10 is newly distributed on the same stored goods carriers 8, so that the stored goods carriers 8 may be arranged more compactly above one another. The number of stored goods carriers remains the same. The overall stack height is not necessarily a variable that is used in calculating the stored good redistribution reduced by lost space. However, the stored good redistribution reduced by lost space is characterized by a decrease in the overall stack height.

FIG. 10 schematically illustrates the overall stack height 56 of the stored goods carriers 8. If the stored good 10a is redistributed, the stored goods carriers 8 in the storage rack 18 may be packed more compactly above one another. In the stored good redistribution that is reduced by lost space, a stored good 10 having approximately the same height is preferably situated on the same stored goods carrier 8. The overall stack height 56 of the stowed stored goods carriers 8 decreases, and for example after the stored good redistribution that is reduced by lost space, at least one further, additional stored goods carrier 8 may be accommodated in a storage rack 18. For example, a Monte Carlo simulation or a machine learning program such as a network that is trained based on such or similar simulations is suitable for calculating the stored good redistribution reduced by lost space.

FIG. 3 shows a storage system in which the height measuring system 24 is situated in the storage shaft 16. The height measurement data 28 are determined during the transport of the stored goods carrier 8 in the storage shaft 16 by the conveying device 12 along the transport direction 36.

As an example, a light grid or light curtain 34 is shown which is oriented perpendicularly to the end faces 57 of the storage racks 18 bordering the storage shaft 16. The light grid or the light curtain 34 is aligned transversely across the storage shaft 16 from one storage rack 18 to the other. When the stored goods carrier 8 together with the stored good 10 is transported in the vertical direction, the interruption of the light curtain and the instantaneous position of the conveying device 12 or of the stored goods carrier 8, which is continuously provided to the data processing device 30, allow a height 26 to be determined. In addition or as an alternative to the light grid or light curtain 34, a further light grid or further light curtain 34a may be used. The further light grid 34a or the further light curtain 34a is preferably oriented perpendicularly to the light grid 34. The measuring plane 58 of the light grid or light curtain 34 may be oriented in parallel to the measuring plane 58a of the light grid or light curtain 34a. In the embodiment shown, the further light grid 34a or the further light curtain 34a is the detector device 24 (also referred to as the height measuring system 24). The detector device is made up of the plurality of reflection light sensors 25.

Due to the different orientations of the light grid 34 and of the further light grid 34a, i.e., the detector device 24, with respect to the movement direction 36 of the stored goods carrier 12 [sic; 8] compared to FIG. 1, the grid pattern 40 for the height measurement has a different orientation than in FIG. 1. The grid pattern 40 in this case is a width grid or a depth grid.

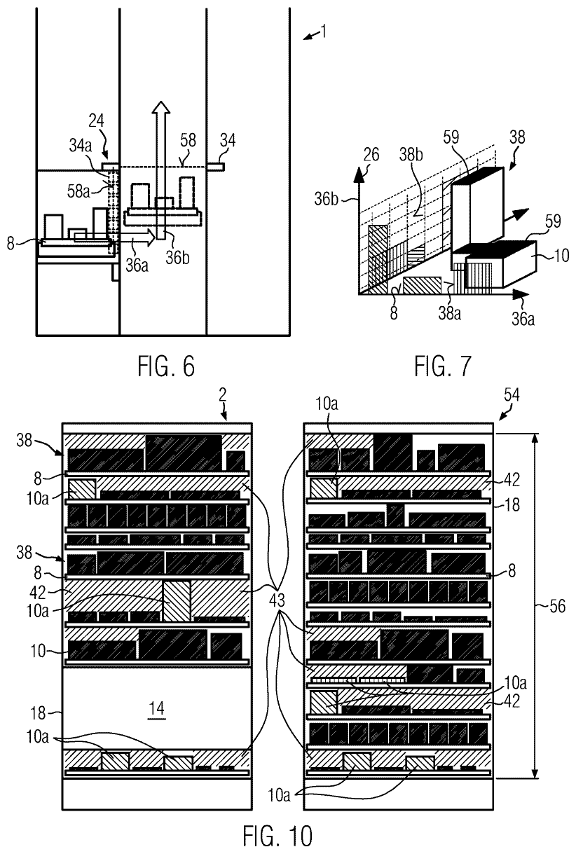

When the two light grids or light curtains 34, 34a in FIG. 3 are used together, a two-dimensional height distribution 38 may be determined due to the different orientations, in the present case mutually perpendicular to one another, since height measurement data 28 are present in two different directions in the measuring plane 58. FIG. 6 shows another embodiment for determining two-dimensional height measurement data.

In the design in FIG. 6, the height measuring system 24 has light curtains or light grids 34, 34a that are spaced apart transversely from the path 36a, 36b that is traveled by a stored goods carrier 8 during the storage. Each light curtain or each light grid 34, 34a is oriented perpendicularly to the transport direction. The one light grid or the one light curtain 34a corresponds to the light curtain 34 in FIG. 1, for example, and at the same time may be part of a security system which in the unarmed state measures a height distribution 38a along the direction 36a. The direction 36a in FIG. 6 corresponds to the direction 36 in FIG. 1. Although the two light curtains or light grids 34, 34a in FIG. 6 are spaced apart from one another and detect the height measurement data at different times in respectively different, for example mutually perpendicular, spatial directions 36a, 36b and in mutually perpendicular measuring planes 58, 58a, they may be used to determine a shared two-dimensional height distribution 38, as schematically illustrated in FIG. 7. The distribution of the stored good 10 on a stored goods carrier 8 may thus be calculated by the data processing device 30 from the two one-dimensional partial height distributions 38a, 38b. The height distribution as illustrated in FIG. 7 may also be determined using the embodiment in FIG. 3 when both light curtains or light grids 34, 34a are used together.

The lost space 42 above a stored goods carrier 8 may be calculated more accurately using a two-dimensional height distribution 38. Based on the two-dimensional height distribution 38, it is also possible to determine the base areas 59 of the stored goods 10, so that it may be exactly determined whether a stored good that results in lost space 42 can actually be exchanged with a stored good 10 on another stored goods carrier 8. Namely, such an exchange is possible only when a sufficient base area is present on the stored goods carriers 8 to receive the respective other stored good.

When reference is made above to a light curtain or light grid, the intent is to use them in particular for detecting contactlessly operating systems for height measurement that include a plurality of reflection light sensors. These reflection light sensors may each have a light beam and/or laser beam. The plurality of reflection light sensors is able to scan a measuring plane 58 so quickly, in comparison to the transport speed of the stored goods carrier 8, that changes in height that result during the sampling period may be disregarded.

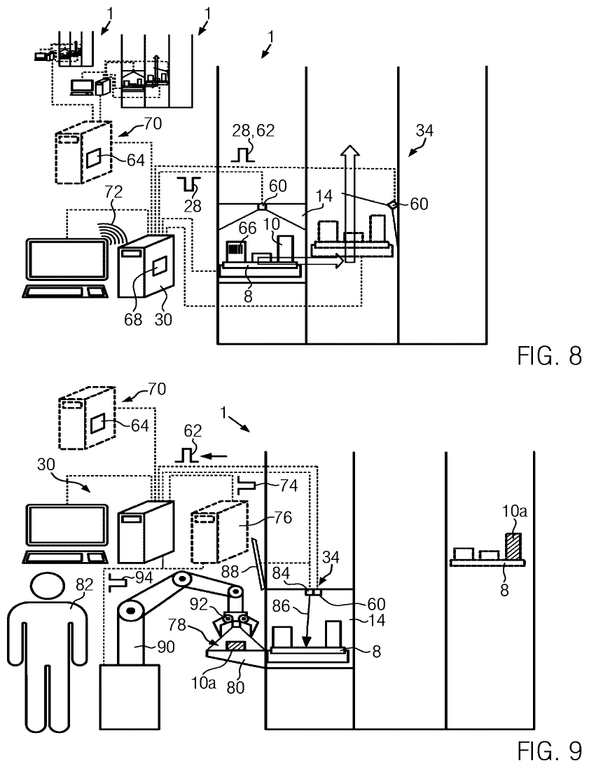

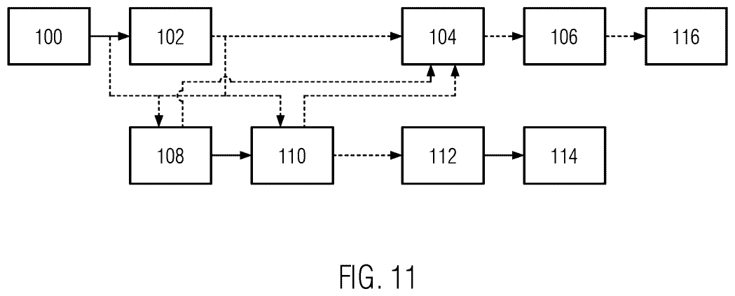

The drawback of a light curtain or light grid 34 that measures in a measuring plane 58 is that stored goods situated one behind the other may cast shadows on each other. To avoid this, the height measuring system 24 may have one or more cameras, for example one or more CCD cameras, one or more light sensors, or one or more scanners 60 that generate image-like, two-dimensional height measurement data 28. This is shown in FIG. 8. For example, a lidar scanner or a camera that projects a light grid onto the stored good 10 or the stored goods carrier 8 may be used as a camera or scanner 60. The height measurement data 28 in this case may be implicitly contained in image data 62. The image data 62 may represent a black-and-white image or a color image in any given color space.

The image data 62 may be further used to identify an individual stored good 10. For example, the data processing device 30 may be designed to recognize a code 66 on the stored good 10, on the stored goods carrier, or on a small parts container or a compartment and retrieve the data, corresponding to this code 66, from a database 64. For example, a QR code or barcode may be affixed to a stored good 10 or a stored goods carrier or to a small parts container or a compartment and be recognized by the height measuring system 24. Information from a database 64, such as package size, a brief description of the stored good 10, the weight of the stored good 10, and/or a position of the stored good 10 on the stored goods carrier 8, may be determined by use of the code 66. The code 66 allows identification of the stored good 10 by the data processing device 30. For this purpose, the data processing device 30 may have a code reader 68 that is implemented as hardware and/or software and that identifies the code in the image data 62. The database 64 may be part of a higher-order storage management system 70, which as a higher-order control entity controls and/or manages a plurality of storage systems 1.

As soon as the height distribution 38 of a stored goods carrier 8 and its storage place 4 for the height-dependent storage is determined, the data processing device 30 can calculate the lost space 42 and/or the total lost space 43 and/or the overall stack height 56. In one variant, as soon as a predetermined limit value, which is preferably changeable by the operator, is exceeded for at least one of the parameters lost space, total lost space 43, and/or overall stack height 56, an acoustic and/or optical warning signal 72 may be output, or the output thereof may be prompted. Alternatively or additionally, the data processing device 30 may indirectly or directly prompt the stored goods carrier 8 to be automatically transported back into the service opening 14 or not transported from the service opening 14, in order to not waste storage space and to bring about immediate reloading of the stored good.

The data processing device 30 may be designed to indirectly or directly prompt the automatic transport of stored goods carriers 8 with a stored good 10a which, in the course of the stored good redistribution that is reduced by lost space, is to be rearranged on another stored goods carrier 8. This is explained below with reference to FIG. 9. For indirect prompting, the data processing device 30 transmits control commands 74 to a control unit 76 of the conveying device 12 and/or of the transfer device 22 (not shown in FIG. 9). The control unit 76 then takes over the actual control of the conveying device 12 and/or of the transfer device 22. For direct prompting, the data processing device 30 is designed to itself control the conveying device 12 and/or the transfer device 22.

The data processing device 30 is preferably designed to automatically determine a sequence of the transport of the stored goods carriers 8 with the stored goods 10a to be rearranged, so that at all times it is necessary only to deposit a minimum number of stored goods 10a, to be rearranged, in a temporary storage space 78, for example a delivery table 80.

If the rearrangement is performed manually, i.e., by operating personnel 82, it is advantageous for a pointing system 84, for example a laser pointer, to designate the stored good 10a to be rearranged in the service opening 14. If the height measuring system 24 includes a scanner or a camera 60 that is designed to automatically project one or more light beams or a pattern, for example a cross, onto a predefinable location, a light beam 86 that marks the stored good 10a to be rearranged may also be generated by the height measuring system 24.

As soon as the stored good 10a, in the course of a stored good redistribution that is reduced by lost space, is to be rearranged and a stored goods carrier 8 with a stored good 10a to be rearranged is present in the service opening 14, the operator 82 can accordingly recognize the stored good 10a that is marked by the light beam 86 and, for example, deposit it on the table 80. Upon a control command of the operator 82, for example by touching a marking on a touch-sensitive display 88, the stored goods carrier 8 is subsequently transported back into the storage area 2, without the stored good 10a to be rearranged. The operator 82 may have placed a stored good 10a, previously deposited for the rearrangement, on the stored goods carrier 8.

The next stored goods carrier 8 with the stored good 10a, which is to be exchanged with the temporarily stowed stored good 10a, is then automatically transported into the service opening 14. These steps are continued until all stored goods 10a to be rearranged have been rearranged.

The display 88 may be provided to facilitate for the operator the recognition of the stored good 10a to be rearranged 82, in addition to or instead of the pointing system 84, and/or to control the storage system 1. Thus, for example, the display 88 may represent the height distribution 38 or some other depiction of the stored good 10a on the stored goods carrier 8 in the service opening 14, in which the stored good 10a to be rearranged is marked. At the same time, further information concerning the stored good 10a to be rearranged may be displayed, for example information from the storage management system 70 or the database 64.

Of course, during a rearrangement of a stored good 10a in the course of the stored good redistribution reduced by lost space, multiple stored goods 10a may also be removed from a stored goods carrier 8, and only a partial quantity of these removed stored goods 10a can then be deposited on the next provided stored goods carrier 8. Which of the stored goods 10a that are to be deposited may be indicated on the display 88.

The rearrangement in the course of the stored good redistribution that is reduced by lost space may also take place fully automatically, for example using a robot 90 that performs the same activities as the operator 82. The robot 90 may be provided with a camera 92 that detects the stored good 10a to be transferred, based on image data on the stored goods carrier 8 in the service opening 14, and/or based on the light beam 86 directed thereon. Alternatively or additionally, the robot 90 may be supplied with control signals which contain in encoded form the position of the stored good 10a, to be rearranged, on the stored goods carrier 8. The position may be contained in the database 64, for example.

The robot 90 may be controlled directly by the data processing device 30, or indirectly via a control unit 76 mounted in between which, for example, also additionally activates the conveying device 12 and/or the transfer device 22. The data processing device may be designed, for example, to transmit a control signal 94 to the robot 90, which prompts the robot to rearrange or temporarily store a stored good 10a to be rearranged.

FIG. 11 provides an overview of the method for storage space optimization. Height measurement data 28 are determined in a step 100. Based on the height measurement data 28, a height distribution 38 of the stored good 10a on the stored goods carrier 8 is then determined in a step 102. Steps 100 and 102 are repeated for a plurality of stored goods carriers 8 of the storage system 1, preferably for all stored goods carriers 8. This may occur whenever, in the storage system 1, a stored goods carrier 8 is transported past the height measuring system 24 and/or is situated in the service opening 14.

The image data set 48 is generated in a step 104 and represented in an optional step 106. Based on the height measurement data 28 or the height distribution 38, the lost space 42 of at least a portion of the stored goods carriers 8, the total lost space 43, and/or the overall stack height 56 are/is determined in an optional step 108.

A stored good redistribution that is reduced by lost space is calculated in a step 110, based on the lost space 42, the total lost space 43, and/or the overall stack height 56, and/or as a function of the height measurement data 28 and/or the height distributions 38. In step 104, the stored good 10a to be rearranged in the course of the stored good redistribution that is reduced by lost space may be taken into account when generating the image data set 48, so that a stored good 10a, to be rearranged, in the image data set 48 may be marked in the depiction 54, represented by the image data set 48, differently than a stored good 10 that is not to be rearranged. If no stored good redistribution that is reduced by lost space is determined, the stored good 10a to be rearranged may also be marked in the depiction 54 as a function of the height distribution 38, the height measurement data 28, or of the lost space 42, total lost space 43, and/or overall stack height 56 determined in step 108.

When the stored good redistribution that is reduced by lost space is determined, in an optional step 112 the stored goods carriers 8 with stored goods 10a to be rearranged may be automatically transported or their transport may be prompted, preferably in the order of the rearrangement. The rearrangement takes place manually or fully automatically in a step 114 by means of a robot 90.

Instead of the automatic transport 112, transport of a stored goods carrier 8 may be initiated manually at any time, for example based on the depiction 54 represented in step 106. This is schematically indicated by step 116.

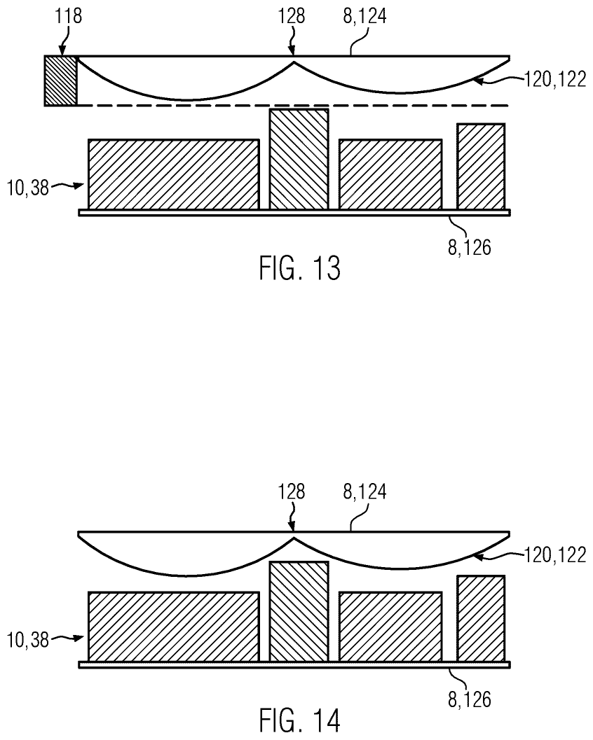

FIGS. 13 through 15 schematically show, not true to scale, a deflection 120 of the stored goods carrier 8. The order picking device 1 (not shown here) may be designed to determine a deflection 120 of the stored goods carrier 8 and/or calculate a value that is representative of the deflection 120. The order picking device 1 may thus have a deflection module 118, which is only schematically shown in FIG. 13.

Such a deflection module 118 may qualitatively determine whether the stored goods carrier 8 is deflected, and/or may quantitatively determine a magnitude, i.e., extent, of the deflection 120. The deflection module 118 may have scales or may be scales. By use of scales, it is possible to detect a weight value of the stored good 10 situated on the stored goods carrier 8, and to calculate the deflection 120 as a function of this weight value. In other embodiments (not shown), a sensor may be situated at the base of the stored goods carrier 8 or below the stored goods carrier 8, and designed to determine the deflection 120.

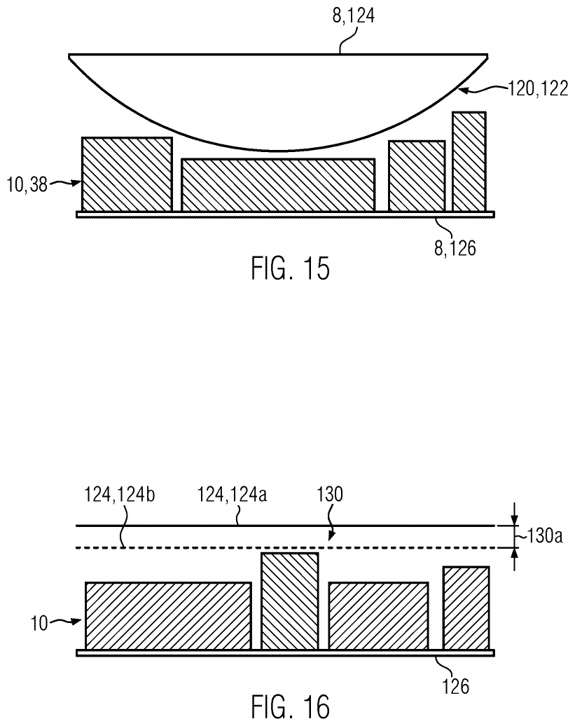

Different deflection distributions 122 may be obtained, depending on the geometry of the stored goods carrier 8. For example, the stored goods carrier 8 in FIG. 13 may have a central reinforcement 128, thus forming two deflections, in each case from the reinforcement toward the border of the stored goods carrier 8. Without such a reinforcement, which is mentioned as an example, the deflection 120 may extend over the entire stored goods carrier 8. This is illustrated in FIG. 15.

As shown in FIGS. 14 and 15, the order picking device 1 may be designed to use a deflection distribution 122, determined by the deflection module 118, for optimizing storage space, and to arrange an upper stored goods carrier 124, having a corresponding deflection distribution 122, above a lower stored goods carrier 126, wherein the lower stored goods carrier 126 has a height distribution 38 of the stored good 10 that is approximately complementary to the deflection distribution 122 of the upper stored goods carrier 124.

Even if it is determined that the stored goods carrier 8 has no deflection 120, this may be used to optimize the storage space. This is schematically illustrated in FIG. 16.

In the prior art, a possible deflection 120 of the stored goods carrier 8 is taken into account by reserving a safety area 130. This safety area 130 is not available for the storage of stored goods 10.

In one embodiment of the order picking device 1, the safety area 130 provided below the stored goods carrier may be decreased as a function of the deflection 120.

For example, if the deflection module 118 determines that the stored goods carrier 8 is not deflected, the safety area 130 in whole or in part may be declared as a usable storage volume, so that the stored good 10 of the lower stored goods carrier 126 situated therebelow may be situated in the safety area. This is schematically illustrated in FIG. 16.

The safety area 130 is situated between the upper stored goods carrier 124 and the stored good 10 of the lower stored goods carrier 126. The safety area 130 extends to the lower stored goods carrier 126, and one end of the safety area 130 is illustrated by a dashed line. The stored good 10 of the lower stored goods carrier 126 is thus always situated at a safety distance 130a from the upper stored goods carrier 124. The safety distance 130a corresponds to the size of the safety area 130. If no deflection 120 is detected, the upper stored goods carrier 124 may be moved from a first position 124a (with the safety area 130) into a second position 124b (without the safety area 130). In this position, the available storage space is increased, corresponding to the previously established safety distance 130a.

### LIST OF REFERENCE NUMERALS

1 storage system/order picking device
2 storage area
4 storage places
6 grid spacing
8 stored goods carrier
10 stored good
10a stored good to be redistributed
12 conveying device
14 service opening/retrieval and/or storage point
15 enclosure
16 storage aisle
18 storage rack
20 spatial direction
22 transfer device
24 height measuring system/detector device
25 reflection light sensor
25a scanning range
25b distance
26 height
28 height measurement data
30 data processing device
31 processor
32 transition area between the service opening and the storage area
34 light curtain/light grid
34a further light curtain/further light grid
36 measuring direction for the height distribution
36a, 36b different measuring directions in the two-dimensional height distribution
38 height distribution
38a, 38b one-dimensional height distributions as parts of a two-dimensional height distribution
40 height/width/depth grid
42 lost space
43 total lost space
44 area/volume
46 area/volume
48 image data set
50 display
52 image
54 depiction
55 marking
56 overall stack height
57 end face of a storage rack
58, 58a measuring plane
59 base area of a stored good
60 camera/scanner
62 image data
64 database
66 code
68 code reader
70 storage management system
72 warning signal
74 control command
76 control unit
78 temporary storage space
80 table
82 operating personnel
84 pointing system
86 light beam
88 display
90 robot
92 camera of the robot
94 control signal for robots
100 determination of height measurement data
102 determination of the height distribution
104 determination of the image data set
106 representation of the depiction
108 determination of lost space, total lost space, and/or overall stack height
110 determination of the stored good redistribution reduced by lost space
112 automatic transport for redistribution
114 rearrangement
116 manual initiation of a transport for rearrangement
118 deflection module
120 deflection
122 deflection distribution
124 upper stored goods carrier
124a first position
124b second position
126 lower stored goods carrier
128 central reinforcement
130 safety area
130a safety distance

1. An order picking device (1), in particular a storage lift, with at least one retrieval and/or storage point (14) for stored goods (10) and/or stored goods carriers (8), wherein the order picking device (1) has at least one detector device (24) for determining a height distribution (38) of the stored good (10) or of the stored goods carrier (8) and for providing data (28) that represent the height distribution (38), and wherein the detector device (24) includes a plurality of reflection light sensors (25) arranged in parallel to one another.

2. The order picking device (1) according to claim 1, wherein the reflection light sensors (25) are directed vertically downwardly.

3. The order picking device (1) according to claim 1, wherein the reflection light sensors (25) are arranged along at least one line.

4. The order picking device (1) according to claim 1, including a transport path along which the stored good (10) and/or the stored goods carrier (8) is transported between the at least one retrieval and/or storage point (14) and a storage place, with the plurality of reflection light sensors (25) situated transversely to the transport path.

5. The order picking device (1) according to claim 4, wherein the plurality of reflection light sensors (25) is situated at a top side of the transport path.

6. The order picking device (1) according to claim 1, wherein the plurality of reflection light sensors (25) is situated at a top side of the retrieval or storage point (14).

7. The order picking device (1) according to claim 1, including a system for data processing (30) that is connected to the detector device (24),
wherein the system for data processing (30) is designed to calculate, based on the height distribution (38) provided by the detector device (24), a stored good redistribution that is reduced by lost space, in which at least a portion of the stored goods (10) in the order picking device (1) are distributed differently on the stored goods carriers (8) than on the stowed stored goods carriers (8), wherein an overall stack height (56) of the stored goods carriers (8) in the stored good redistribution that is reduced by lost space is less than the overall stack height (56) of the same stowed stored goods carriers (8).

8. The order picking device (1) according to claim 1, including a system for data processing (30) that is connected to the detector device (24) or the order picking device (1) according to claim 7, wherein the system for data processing (30) is designed to generate an image data set (48) that represents a depiction (54) of the stored goods carriers (8), stored in the storage places (4), with the height distribution (38) of the stored good (10) on the particular stored goods carrier (8) at its storage place (4) in the order picking device (1).

9. The order picking device (1) according to claim 7, wherein the system for data processing (30) is designed
to provide a user (82) with the image data set (48) graphically, optically, acoustically, or haptically, and/or to provide a user (82) with handling instructions for reloading stored goods (10) from a stored goods carrier (8) onto another stored goods carrier (8) of the order picking device (1) as a function of the stored good redistribution that is reduced by lost space; or p1 to control a robot (90) for reloading stored goods (10) from one stored goods carrier (8) to another stored goods carrier (8) of the order picking device (1) as a function of the stored good redistribution that is reduced by lost space.

10. The order picking device (1) according to claim 1, wherein the order picking device (1) is designed to detect a deflection (120) of a stored goods carrier (8) or a tray and/or to calculate a value that is representative of the deflection (120).

11. The order picking device (1) according to claim 10, wherein the order picking device (1) is designed to reduce a size (130a) of a safety area (130) as a function of the deflection (120).

12. Use of a plurality of reflection light sensors (25) in an order picking device (1) for determining a height distribution (38) of the stored goods (10) or of the stored goods carrier (8).

13. A method for calculating a height distribution (38) of stored goods (10) on a stored goods carrier (8), comprising determining a location-dependent height (26) of stored goods (10) using a plurality of reflection light sensors (25) arranged in parallel to one another.

14. The method according to claim 13, further comprising providing height data (28), representing the location-dependent heights (26), to a system for data processing (30), and calculating the height distribution (38) from the height data (28).

15. The method according to claim 13, wherein the method step of determining the location-dependent height (26) of a stored good (10) includes the relative movement of the plurality of reflection light sensors (25), arranged in parallel to one another, with respect to the stored good (10).

16. A method according to claim 13 further comprising providing a computer program product that includes commands which, when the computer program product is executed by a computer, prompt the computer to carry out the method.

17. A method according to claim 16 further comprising providing a computer-readable data medium on which the computer program product is stored.
